(19) United States
(12) Patent Application Publication
(10) Pub. No.: US 2007/0103751 A1
(43) Pub. Date: May 10, 2007

(54) Optical component, optical recording medium, and manufacturing method therefor

(75) Inventors: Tetsuro Mizushima, OSAKA (JP); Hideaki Miura, Tokyo (JP); Takuya Tsukagoshi, Kanagawa (JP); Jiro Yoshinari, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 10/581,089

(22) PCT Filed: Nov. 18, 2004
(86) PCT No.: PCT/JP04/17169

§ 371 Date: May 31, 2006

(30) Foreign Application Priority Data
Dec. 3, 2003 (JP) 2003-404999

(51) Int. Cl. G03H 1/04

(52) U.S. Cl. 359/35

(57) ABSTRACT

When an optical material layer such as an organic-inorganic hybrid material is employed as an optical component or an optical recording medium, the effect of thickness unevenness caused by drying is eliminated. An optical recording medium 20 is configured by providing on a substrate 10 an organic-inorganic hybrid material layer 12 applied thereto and dried thereon, covering this layer with an organosilicon resin 16, and stacking a translucent substrate 18 on the organosilicon resin 16. The effect of the thickness unevenness of the hybrid material layer 12 is eliminated by reducing the refractive index difference between the hybrid material layer 12 and the organosilicon resin 16 to thereby make them optically continuous and integrated.

### TECHNICAL FIELD

This invention relates to optical components such as various recording materials, holographic recording materials, photosensitive materials, photochromic lens materials, and optical filter materials, to an optical recording medium, and to a manufacturing method therefor.

### BACKGROUND ART

As the optical components and the manufacturing method therefor described above, for example, in Japanese Patent Laid-Open Publication No. Hei 7-5623, a photochromic glass thin film has been disclosed which is formed on the surface of a translucent substrate and is constituted by a matrix composed of inorganic gel or glass, an organic photochromic compound contained in the matrix, and a dispersing agent.

Further, in Japanese Patent Laid-Open Publication No. 1999-344917, as an optical recording medium employed in a holographic recording system, an optical forming system has been disclosed which contains a glassy hybrid inorganic-organic three-dimensional matrix comprising one or more photoactive organic monomers.

Moreover, in Japanese Patent Laid-Open Publication No. 2002-236439, a photosensitive composition for volume holographic recording and a photosensitive medium for volume holographic recording have been disclosed. This photosensitive composition for volume holographic recording contains: an organic-inorganic hybrid polymer which is prepared by copolymerization of an organometallic compound and an organic monomer having an ethylenically unsaturated double bond and/or a hydrolyzed polycondensation product thereof; a photopolymerizable compound; and a photopolymerization initiator.

Since generally the abovementioned optical materials, particularly the holographic materials, are applied onto a substrate and are solidified (gelated) through a drying step, it is difficult to manufacture these materials. Therefore, these materials in the solidified state are employed as they are. However, wave-like thickness unevenness may be formed on a film surface during the drying step. If this is employed as an optical component or an optical recoding medium, a problem arises that optical noise such as scattering due to the abovementioned thickness unevenness is generated.

### DISCLOSURE OF THE INVENTION

This invention has been made in view of the abovementioned conventional problems. Accordingly, it is an object of the present invention to provide an optical component and an optical recording medium in which the wave-like thickness unevenness caused in a material during the drying step can be corrected without performing processing and also to provide a manufacturing method therefor.

The present inventors have conducted intensive studies and consequently found that the abovementioned film thickness unevenness can be corrected by coating the surface of a material after drying with a layer of organosilicon resin such as silicone oil to thereby eliminate the scattering and aberration caused by the film thickness unevenness.

In summary, the above-described objectives are achieved by the following aspects of the present invention.

(1) An optical component, comprising a substrate, an optical material layer which is formed on this substrate, an organosilicon resin layer which covers this optical material layer, and a solid component which is stacked on this organosilicon resin layer, wherein the optical material layer is prepared by drying a material containing any of a hydrolyzed solution of metal alkoxide, a solution of a polymer and a polymerizable monomer dissolved in an organic solvent, and a solution of an ionic bond crystal material dissolved in a solvent.

(2) The optical component according to (1), wherein a spacer which surrounds an outer periphery of the optical material layer is provided between the substrate and the solid component, the spacer being formed to have a thickness larger than that of the optical material layer.

(3) The optical component according to (1), wherein a spacer is formed between the substrate and the solid component by curing an outer periphery of the optical material layer, the spacer being formed to have a thickness larger than that of an inner portion of the outer periphery of the optical material layer.

(4) An optical component, comprising a substrate, an optical material layer which is formed on this substrate, an organosilicon resin layer which covers this optical material layer, and a spacer which surrounds an outer periphery of the optical material layer, wherein: the optical material layer is prepared by drying a material containing any of a hydrolyzed solution of metal alkoxide, a solution of a polymer and a polymerizable monomer dissolved in an organic solvent, and a solution of an ionic bond crystal material dissolved in a solvent; and the spacer is formed to have a thickness larger than that of the optical material layer.

(5) An optical component, comprising a substrate, an optical material layer which is formed on this substrate, an organosilicon resin layer which covers this optical material layer, and a spacer which is formed by curing an outer periphery of the optical material layer, wherein: the optical material layer is prepared by drying a material containing any of a hydrolyzed solution of metal alkoxide, a solution of a polymer and a polymerizable monomer dissolved in an organic solvent, and a solution of an ionic bond crystal material dissolved in a solvent; and the spacer is formed to have a thickness larger than that of an inner portion of the outer periphery of the optical material layer.

(6) The optical component according to any one-of (1) to (5), wherein a refractive index of the optical material layer is approximately the same as a refractive index of the organosilicon resin.

(7) The optical component according to any one of (1) to (6), wherein the optical material layer is formed of the metal alkoxide, and the metal alkoxide contains Si alkoxide as a main ingredient.

(8) The optical component according to any one of (1) to (7), wherein; the optical material layer is formed of a single material having a refractive index of n; and a refractive index n₀ of the organosilicon resin layer satisfies n−0.05<n₀<n+0.05.

(9) The optical component according to any one of (1) to (7) wherein: the optical material layer comprises a material having a refractive index of n₁, and a material having a refractive index of n₂, n₁ being smaller than n₂; and a refractive index n₀ of the organosilicon resin layer satisfies n₁<n₀<n₂.

(10) The optical component according to (9), wherein: the optical material layer is formed of three or more types of materials including a material having a maximum refractive index nₘₐₓ and a material having a minimum refractive index nₘᵢₙ; and the refractive index n₀ of the organosilicon resin layer satisfies nₘᵢₙ<n₀<nₘₐₓ.

(11) An optical recording medium, wherein the solid component in the optical component according to any one of (1) to (10) is configured to serve as a translucent substrate provided parallel to the substrate.

(12) A manufacturing method for an optical component, comprising the steps of: applying a material among materials containing any of a hydrolyzed solution of metal alkoxide, a solution of a polymer and a polymerizable monomer dissolved in an organic solvent, and a solution of an ionic bond crystal material dissolved in a solvent; forming a gel-like or solid-like optical material layer by removing a solvent from the applied material through drying; coating this gel-like or solid-like optical material layer with an organosilicon resin layer; and stacking the solid component with the optical material layer and the organosilicon resin layer sandwiched between the substrate and the solid component.

(13) The manufacturing method for an optical component according to (12), comprising the step of surrounding an outer periphery of the optical material layer with a spacer having a thickness larger than a maximum thickness of the outer periphery, and wherein: a solution material containing the optical material is injected inside a portion surrounded by the spacer; and the solid component is abutted onto the spacer to position the solid component with respect to the substrate.

(14) The manufacturing method for an optical component according to (12), comprising the step of curing an outer periphery of the optical material layer such that a height thereof is larger than a thickness of an inner portion thereof, and wherein the solid component is stacked so as to abut onto the cured outer periphery.

(15) The manufacturing method for an optical component according to (14), wherein, after the outer periphery of the optical material layer is pressed to make the height uniform, the outer periphery is irradiated with a ray for curing.

(16) A manufacturing method for an optical recording medium, wherein the solid component in the step of stacking the solid component according to any one of (12) to (15) is a translucent substrate.

### BRIEF DESCRIPTION OF THE DRAWINGS

FIG. 1 is a flowchart showing a manufacturing method for an optical recording medium according to an embodiment of the present invention.

FIG. 2 includes a series of cross-sectional views illustrating a process of manufacturing the optical recoding medium by means of the manufacturing method.

FIG. 3 includes a series of cross-sectional views illustrating a process of manufacturing an optical recoding medium according to a second embodiment of the present invention.

FIG. 4 is a cross-sectional view illustrating an optical recoding medium according to a third embodiment of the present invention.

### BEST MODE FOR CARRYING OUT THE INVENTION

The abovementioned object is achieved by forming an optical component from: a substrate; an optical material layer which is formed on this substrate and is prepared by drying an organic-inorganic hybrid material in which metal alkoxide is employed; a spacer which is provided so as to surround this optical material layer; an organosilicon resin layer which covers the abovementioned optical material layer within the spacer; and a solid component which is stacked through this organosilicon resin layer so as to abut on the abovementioned spacer.

[First Embodiment]

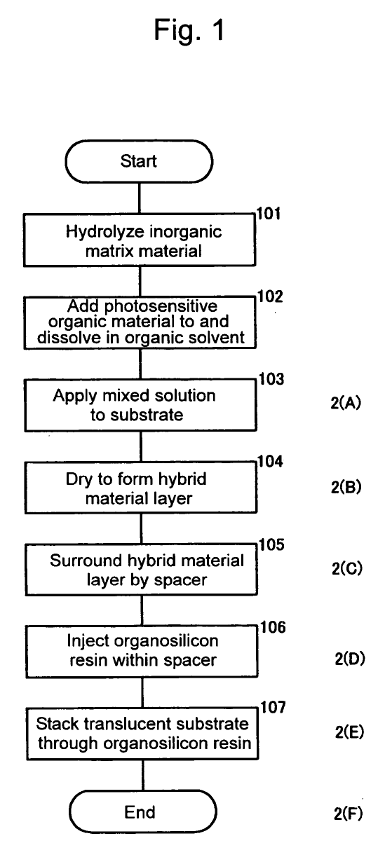

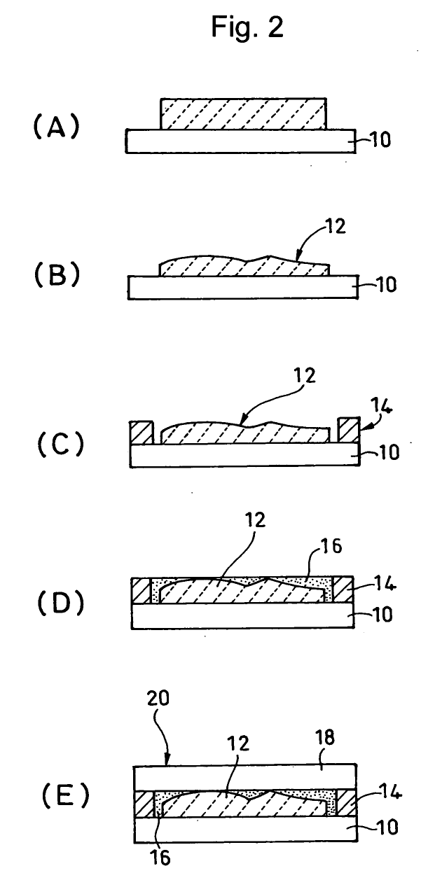

Next, a manufacturing method for an optical recording medium according to a first embodiment of the present invention will be described with reference to FIGS. 1 and 2.

As shown in FIG. 1, in step 101, a solution of an inorganic matrix material having a metal-alkoxide bond -M-(OR) (M: a metal element, R: an alkyl group) is hydrolyzed. In the next step 102, the solution is mixed with a photosensitive organic material and is dissolved into an organic solvent. Here, the hydrolysis is performed on the abovementioned inorganic matrix material but is not limited thereto. The hydrolysis may be performed on the mixed solution prepared by mixing the inorganic matrix material with the photosensitive organic material.

In step 103, the abovementioned mixed solution is applied to a substrate (a first substrate) 10 (see FIG. 2 (A)). In the next step 104, while the abovementioned applied mixed solution is dried, the gelation of the inorganic matrix material proceeds, whereby an organic-inorganic hybrid material layer 12 in which the organic material is filled into an inorganic matrix network is obtained on the substrate 10.

Through the abovementioned drying step, the hybrid material layer 12 is formed on the substrate 10 as mentioned above. However, in this state, wave-like thickness unevenness is present as shown in FIG. 2(B), and this thickness unevenness causes optical noise such as scattering upon use as, for example, an optical recording medium.

In step 105, the abovementioned hybrid material layer 12 is surrounded by a ring-like spacer 14 as shown in FIG. 2(C).

Next, in step 106, an organosilicon resin 16 formed of, for example, a silicone oil is injected within the abovementioned spacer 14 as shown in FIG. 2(D).

Next, in step 107, as shown in FIG. 2(E), a translucent substrate (a second substrate) 18 such as a glass plate is stacked through the abovementioned organosilicon resin 16 so as to abut on the upper surface of the abovementioned spacer 14. In this manner, an optical recording medium 20 shown in FIG. 2(E) is completed.

The abovementioned organosilicon resin 16 is selected so as to have the same refractive index as that of the abovementioned hybrid material layer 12. For example, the hybrid material layer is constituted by the inorganic matrix material having a refractive index of n₁ and the photosensitive organic material having a refractive index of n₂. Therefore, the selection is made such that the refractive index n₀ of the abovementioned organosilicon resin layer 16 satisfies n₁<n₀<n₂ (when n₁<n₂). Also, when the refractive index of the hybrid material layer is n, the selection may be made such that n−0.05<n₀<n+0.05 is satisfied. In this manner, the hybrid material layer 12 and the organosilicon resin 16 become optically continuous and integrated. Thus, an optical path length change due to the thickness unevenness of the hybrid material layer 12 can be cancelled out to reduce optical noise.

The abovementioned organosilicon resin comprises a siloxane bond —Si—O—Si and a Si—R (R: an alkyl group or other organic group), is generally referred to as silicone oil, and is excellent in heat resistance and chemical resistance. Thus, the reliability of the optical recording medium 18 can be maintained.

When Si alkoxide is employed in the inorganic matrix material for the abovementioned hybrid material layer 12 (see step 101 in FIG. 1), the hybrid material layer 12 has a Si—O—Si bond and preferably exhibits excellent compatibility with the organosilicon resin 16.

As the organic group of the abovementioned organosilicon resin 16, a methyl group, a phenyl group, or the like may be employed. However, depending on applications, a functional group such as an acrylic group or an epoxy group may be employed. In the abovementioned substrate 10 and the translucent substrate 18, a glass material and a resin material such as polycarbonate or polyolefin may be employed. Further, in the abovementioned spacer 14, a resin material similar to that employed in the translucent substrate 18 may be employed.

[Second Embodiment]

In the first embodiment above, the spacer is employed, but this may be other means capable of forming the gap between the substrate and the translucent substrate.

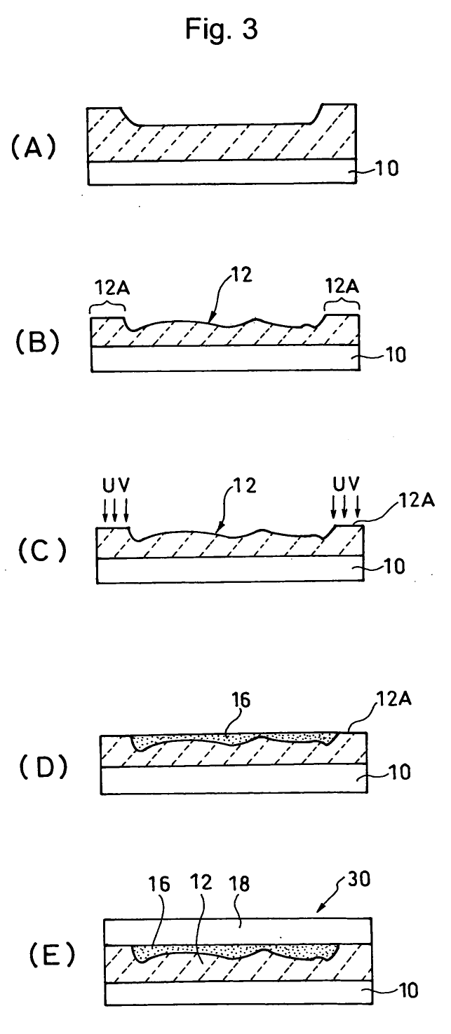

For example, if a photopolymerization material is employed as the abovementioned photosensitive organic material, as in the second embodiment shown in FIG. 3, the outer periphery of the abovementioned hybrid material layer 12 is formed to have a thickness larger than that of the inner portion thereof (see FIG. 3(A)), followed by drying (see FIG. 3(B)). Then, only the outer periphery is irradiated with ultraviolet light for curing as shown in FIG. 3(C). The organosilicon resin 16 is injected within a cured periphery 12A which is used in place of the spacer (see FIG. 3(D)). The translucent substrate 18 is then stacked, and an optical recording medium 30 may be completed (see FIG. 3(E)).

Here, preferably, the outer periphery is irradiated with the ultraviolet light after being subjected to a press process to adjust the height before curing.

[Third Embodiment]

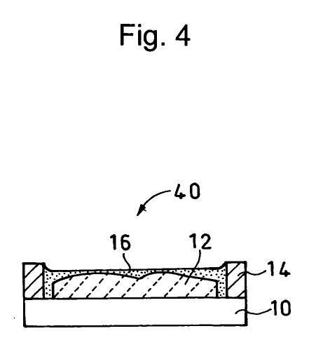

In an optical recording medium (or an optical component) 40 of a third embodiment shown in FIG. 4, the translucent substrate employed in the first and second embodiments is not employed, and the organosilicon resin 16 is exposed.

In the third embodiment, the outer periphery of the organosilicon resin 16 is drawn by the inner periphery of the spacer 14 through the surface tension. However, since the central portion is horizontal and has a uniform thickness, the central portion can be employed as a recording area.

[Fourth Embodiment]

By means of the abovementioned method, an optical recording medium (a holographic recording medium) was produced.

As the inorganic matrix material, tetraethoxysilane and chloropropyltriethoxysilane were employed and were dissolved into a solvent, tetrahydrofuran. This was subjected to a hydrolysis reaction with a solution formed of water, hydrochloric acid, and a solvent (isopropanol), thereby obtaining a sol solution.

As the photosensitive organic material, phenoxy ethyl acrylate (Shin-Nakamura Chemical Co., Ltd., AMP-10G) serving as a photopolymerization monomer and IRG-784 (Ciba Specialty Chemicals) serving as a photopolymerization initiator were employed.

The sol solution obtained as above was mixed with the organic materials, stirred, applied to a first glass substrate, and dried at room temperature for one day, thereby obtaining an organic-inorganic hybrid material formed on the glass substrate and having a thickness of approximately 100 μm.

The refractive index of this organic-inorganic hybrid material was 1.50. Further, the refractive index of the inorganic matrix material was 1.45, and the refractive index of the photosensitive organic material was 1.52.

On the abovementioned glass substrate, a spacer having a thickness of 110 μm was provided so as to surround the abovementioned organic-inorganic hybrid material. The organosilicon resin was applied onto the abovementioned organic-inorganic hybrid material in such a manner that no air bubbles were formed, and a second glass substrate was placed from above in a sandwiching manner, thereby obtaining a shape similar to that shown in FIG. 2(E). As the abovementioned organosilicon resin, methylphenyl silicone oil (refractive index: 1.50) was employed.

In order to prevent the leakage of the abovementioned organosilicon resin, the substrate edge surface of the abovementioned first and second glass substrates was sealed. Further, a substrate having an antireflection coating on the outer side was employed as each of the substrate. The obtained holographic recording medium exhibited excellent recording-reproducing characteristics and no image quality reduction due to scattering and aberration caused by thickness unevenness of the organic-inorganic hybrid material.

Here, the material to which the abovementioned organosilicon resin is applied is not limited to that employed in the embodiments. Any material may be employed so long as it serves as the optical material layer produced through the solvent-drying step. The material exhibiting particularly preferable optical characteristics may be: a material in which a hydrolyzed solution of metal alkoxide is employed, preferably a material containing a photosensitive organic material incorporated into the abovementioned material; a material in which a solution prepared by dissolving a polymer material and a polymerizable monomer into an organic solvent is employed, preferably a material containing a dye or the like dispersed in the abovementioned material; and a material which is prepared by use of a solution containing an ionic bond crystal material dissolved thereinto and by recrystallizing the ionic bond crystal material and which may form an optical material layer containing a material to be employed.

Further, in the embodiments, since the optical material layer is formed of two types of materials, the refractive index no of the abovementioned organosilicon resin layer is set such that n₁<n₀<n₂. However, if the optical material layer can be regarded as being formed of a single material having a refractive index of n, it is desirable that the refractive index n₀ lie in the range of n−0.05<n₀<n+0.05.

When the abovementioned optical material layer is formed of three or more types of materials, and if the maximum refractive index and the minimum refractive index thereof are nₘₐₓ and nₘᵢₙ, respectively, it is desirable that the refractive index no be set such that nₘᵢₙ<n₀<nₘₐₓ.

In this manner, the refractive index difference between the organosilicon resin layer and the optical material layer is reduced, and both the layers are substantially optically continuous and integrated. Therefore, optical noise such as scattering due to the thickness unevenness of the optical material layer can be suppressed.

When the optical material layer is made thick, a frame or the like for holding a solution may be formed on the substrate, and a solution material which forms the optical material layer may be injected within the frame. Moreover, the abovementioned frame may be employed as-is as a spacer surrounding the optical material layer. In the second embodiment, the photopolymerization material is cured by use of ultraviolet light and is employed in place of the spacer. However, the present invention is generally applied to the case in which a material curable through the use of a ray including ultraviolet light is contained.

Further, the abovementioned embodiments are for the optical recording medium, but the present invention is not limited thereto. Another solid component may be stacked in place of the abovementioned translucent substrate, and this may by employed as an optical component other than the optical recording medium. Of course, the present invention is applied to the case in which a translucent substrate or a solid component is not stacked as in the third embodiment.

### INDUSTRIAL APPLICABILITY

In the present invention, by coating, with an organosilicon resin layer, the surface of a material having film thickness unevenness after drying, the thickness is made optically uniform to thereby suppress optical noise such as scattering.

1. An optical component, comprising a substrate, an optical material layer which is formed on this substrate, an organosilicon resin layer which covers this optical material layer, and a solid component which is stacked on this organosilicon resin layer, wherein the optical material layer is prepared by drying a material containing any of a hydrolyzed solution of metal alkoxide, a solution of a polymer and a polymerizable monomer dissolved in an organic solvent, and a solution of an ionic bond crystal material dissolved in a solvent.

2. The optical component according to claim 1, wherein a spacer which surrounds an outer periphery of the optical material layer is provided between the substrate and the solid component, the spacer being formed to have a thickness larger than that of the optical material layer.

3. The optical component according to claim 1, wherein a spacer is formed between the substrate and the solid component by curing an outer periphery of the optical material layer, the spacer being formed to have a thickness larger than that of an inner portion of the outer periphery of the optical material layer.

4. An optical component, comprising a substrate, an optical material layer which is formed on this substrate, an organosilicon resin layer which covers this optical material layer, and a spacer which surrounds an outer periphery of the optical material layer, wherein: the optical material layer is prepared by drying a material containing any of a hydrolyzed solution of metal alkoxide, a solution of a polymer and a polymerizable monomer dissolved in an organic solvent, and a solution of an ionic bond crystal material dissolved in a solvent; and the spacer is formed to have a thickness larger than that of the optical material layer.

5. An optical component, comprising a substrate, an optical material layer which is formed on this substrate, an organosilicon resin layer which covers this optical material layer, and a spacer which is formed by curing an outer periphery of the optical material layer, wherein: the optical material layer is prepared by drying a material containing any of a hydrolyzed solution of metal alkoxide, a solution of a polymer and a polymerizable monomer dissolved in an organic solvent, and a solution of an ionic bond crystal material dissolved in a solvent; and the spacer is formed to have a thickness larger than that of an inner portion of the outer periphery of the optical material layer.

6. The optical component according to claim 1, wherein a refractive index of the optical material layer is approximately the same as a refractive index of the organosilicon resin.

7. The optical component according to claim 1, wherein the optical material layer is formed of the metal alkoxide, and the metal alkoxide contains Si alkoxide as a main ingredient.

8. The optical component according to claim 1, wherein; the optical material layer is formed of a single material having a refractive index of n; and a refractive index n₀ of the organosilicon resin layer satisfies n−0.05<n₀<n +0.05.

9. The optical component according to claim 4, wherein; the optical material layer is formed of a single material having a refractive index of n; and a refractive index n₀ of the organosilicon resin layer satisfies n−0.05<n₀<n+0.05.

10. The optical component according to claim 5, wherein; the optical material layer is formed of a single material having a refractive index of n; and a refractive index no of the organosilicon resin layer satisfies n−0.05<n₀<n+0.05.

11. The optical component according to claim 1, wherein: the optical material layer comprises a material having a refractive index of n₁ and a material having a refractive index of n₂, n₁ being smaller than n₂; and a refractive index n₀ of the organosilicon resin layer satisfies n₁<n₀<n₂.

12. The optical component according to claim 4, wherein: the optical material layer comprises a material having a refractive index of n₁ and a material having a refractive index of n₂, n₁ being smaller than n₂; and a refractive index n₀ of the organosilicon resin layer satisfies n₁<n₀<n₂.

13. The optical component according to claim 5, wherein: the optical material layer comprises a material having a refractive index of n₁ and a material having a refractive index of n₂, n₁ being smaller than n₂; and a refractive index n₀ of the organosilicon resin layer satisfies n₁<n₀<n₂.

14. The optical component according to claim 8, wherein: the optical material layer comprises a material having a refractive index of n₁ and a material having a refractive index of n₂, n₁ being smaller than n₂; and a refractive index n₀ of the organosilicon resin layer satisfies n₁<n₀<n₂.

15. The optical component according to claim 11, wherein: the optical material layer is formed of three or more types of materials including a material having a maximum refractive index nₘₐₓ and a material having a minimum refractive index nₘᵢₙ; and the refractive index n₀ of the organosilicon resin layer satisfies nₘᵢₙ<n₀<nₘₐₓ.

16. The optical component according to claim 12, wherein: the optical material layer is formed of three or more types of materials including a material having a maximum refractive index nₘₐₓ and a material having a minimum refractive index nₘᵢₙ; and the refractive index n₀ of the organosilicon resin layer satisfies nₘᵢₙ<n₀<nₘₐₓ.

17. The optical component according to claim 13, wherein: the optical material layer is formed of three or more types of materials including a material having a maximum refractive index nₘₐₓ and a material having a minimum refractive index nₘᵢₙ; and the refractive index n₀ of the organosilicon resin layer satisfies nₘᵢₙ<n₀<nₘₐₓ.

18. The optical component according to claim 14, wherein: the optical material layer is formed of three or more types of materials including a material having a maximum refractive index nₘₐₓ and a material having a minimum refractive index nₘᵢₙ; and the refractive index n₀ of the organosilicon resin layer satisfies nₘᵢₙ<n₀<nₘₐₓ.

19. An optical recording medium, wherein the solid component in the optical component according to claim 1 is configured to serve as a translucent substrate provided parallel to the substrate.

20. A manufacturing method for an optical component, comprising the steps of:
applying a material among materials containing any of a hydrolyzed solution of metal alkoxide, a solution of a polymer and a polymerizable monomer dissolved in an organic solvent, and a solution of an ionic bond crystal material dissolved in a solvent;
forming a gel-like or solid-like optical material layer by removing a solvent from the applied material through drying;
coating this gel-like or solid-like optical material layer with an organosilicon resin layer; and
stacking the solid component with an optical material layer and the organosilicon resin layer sandwiched between the substrate and the solid component.

21. The manufacturing method for an optical component according to claim 20, comprising the step of surrounding an outer periphery of the optical material layer with a spacer having a thickness larger than a maximum thickness of the outer periphery, and
wherein: a solution material containing the optical material is injected inside a portion surrounded by the spacer; and
the solid component is abutted onto the spacer to position the solid component with respect to the substrate.

22. The manufacturing method for an optical component according to claim 20, comprising the step of curing an outer periphery of the optical material layer such that a height thereof is larger than a thickness of an inner portion thereof, and
wherein the solid component is stacked so as to abut onto the cured outer periphery.

23. The manufacturing method for an optical component according to claim 22, wherein, after the outer periphery of the optical material layer is pressed to make the height uniform, the outer periphery is irradiated with a ray for curing.

24. A manufacturing method for an optical recording medium, wherein the solid component in the step of stacking the solid component according to claim 20 is a translucent substrate.

25. The optical component according to claim 4, wherein a refractive index of the optical material layer is approximately the same as a refractive index of the organosilicon resin.

26. The optical component according to claim 5, wherein a refractive index of the optical material layer is approximately the same as a refractive index of the organosilicon resin.

27. The optical component according to claim 4, wherein the optical material layer is formed of the metal alkoxide, and the metal alkoxide contains Si alkoxide as a main ingredient.

28. The optical component according to claim 5, wherein the optical material layer is formed of the metal alkoxide, and the metal alkoxide contains Si alkoxide as a main ingredient.
